(19) United States
(12) Patent Application Publication
(10) Pub. No.: US 2019/0099970 A1
(43) Pub. Date: Apr. 4, 2019

(54) 3D SHOE UPPER FABRICATION METHOD

(71) Applicant: Faure Corporation, Taichung City (TW)

(72) Inventor: Chu-An HUNG, Taichung City (TW)

(21) Appl. No.: 15/722,955

(22) Filed: Oct. 2, 2017

(51) Int. Cl. B29D 35/00; A43B 23/02; A43D 8/22; B32B 5/02; B32B 38/00; B29D 35/12

(52) U.S. Cl. CPC B29D 35/0054; A43B 23/026; A43D 8/22; A43B 23/0215; B32B 5/022; B29K 2667/00; B32B 38/0004; B29D 35/126; B32B 2437/02; B32B 2262/0276; B32B 5/024

(57) ABSTRACT

A 3D shoe upper fabrication method includes the steps of (A) preparing a shoe upper fabric, (B) preparing a non-woven fabric containing 20˜30 wt % low melting staple fiber and 70˜80 wt % general fiber, (C) bonding two pieces of woven fabric to opposing top and bottom surfaces of the non-woven fabric to form a sandwich middle material and cutting the sandwich middle material into a predetermined shape, (D) bonding the shoe upper fabric to the middle material to form a substrate, (E) preparing a mold, (F) putting the substrate in the mold and then heating and pressurizing the mold to mold the substrate into a 3D shoe upper, and (G) opening the mold and removing the 3D shoe upper thus formed.

### BACKGROUND OF THE INVENTION

### 1. Field of the Invention

The present invention relates to shoe manufacturing technology and more particularly, to a 3D shoe upper fabrication method.

### 2. Description of the Related Art

At present, the general production of shoe upper is manually performed through a series of steps including cutting, bonding, etc. This shoe upper fabrication method is labor-consuming and time-costing. Further, a shoe upper made in this manner neither provides a prominent three-dimensional effect nor allows formation of a three-dimensional pattern.

### SUMMARY OF THE INVENTION

The present invention has been accomplished under the circumstances in view. It is the main object of the present invention to provide a 3D shoe upper fabrication method, which enables the shaped shoe upper to provide a 3D configuration.

It is another object of the present invention to provide a 3D shoe upper fabrication method, which allows formation of a 3D pattern on the shoe upper.

To achieve these and other objects of the present invention, a 3D shoe upper fabrication method includes the steps of: Step A: preparing a shoe upper fabric; Step B: preparing a non-woven fabric containing 20˜30 wt % low melting staple fiber and 70˜80 wt % general fiber; Step C: bonding two pieces of woven fabric to opposing top and bottom surfaces of the non-woven fabric to form a sandwich middle material and cutting the sandwich middle material into a predetermined shape; Step D: bonding the shoe upper fabric to one surface of the middle material to form a substrate; Step E: preparing a mold consisting of an upper die and a lower die with a cavity defined therein for molding a 3D shoe upper; Step F: putting the substrate in the cavity and then heating and pressurizing the mold at 80˜110° C. for 90˜150 seconds to mold the substrate into a 3D shoe upper; and Step G: opening the mold and removing the 3D shoe upper thus formed.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a flow chart of 3D shoe upper fabrication method in accordance with the present invention.

FIG. 2 is a schematic exploded view of the substrate.

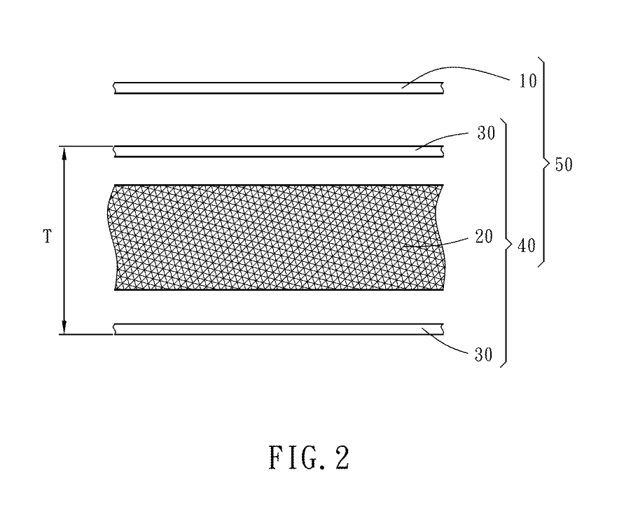

### DETAILED DESCRIPTION OF THE INVENTION

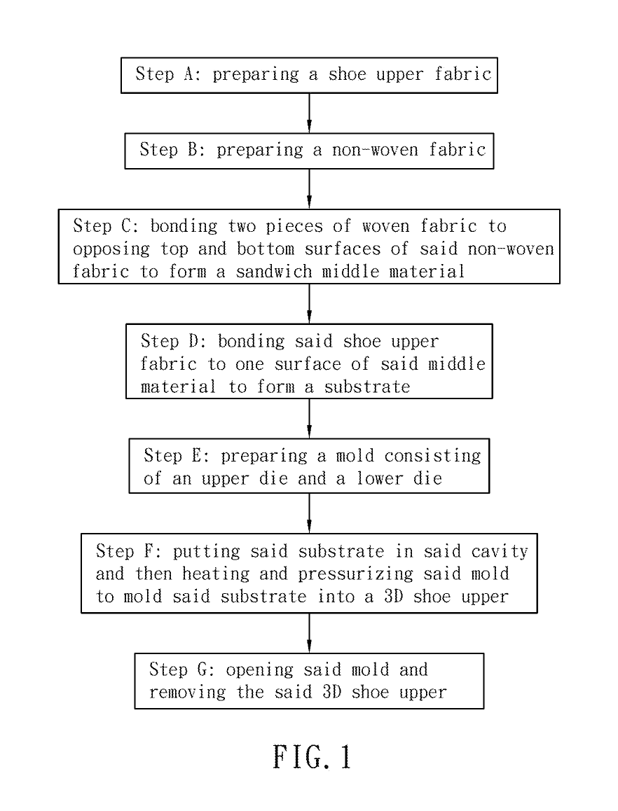

Referring to FIG. 1, a 3D shoe upper fabrication method in accordance with the present invention comprises the steps of:

Step A: Prepare a shoe upper fabric 10 that is a woven fabric made through a warp knitting machine in a predetermined shape and allows formation of a pattern by weaving, heat-transfer printing or printing.

Step B: Prepare a non-woven fabric 20 of thickness T about 4˜6 mm and density about 200˜300 g/m². The non-woven fabric 20 is prepared from low melting staple fiber and general fiber. In this embodiment, the thickness T of the non-woven fabric 20 is 5 mm, and its density is 200 g/m². Further, the weight percentage of the low melting staple fiber is 25%, and the weight percentage of the general fiber is 75%. However, these weight percentages are not a limitation. The weight percentage of the low melting staple fiber can be in the range of 20˜30%, and the weight percentage of the general fiber can be in the range of 70˜80%. The general fiber can be, but not limited to, Polyester or Nylon. The melting point of the non-woven fabric 20 is below 120° C., or 80° C. in the present preferred embodiment.

Step C: Prepare two pieces of woven fabric 30, and then bond these two pieces of woven fabric 30 to opposing top and bottom surfaces of the non-woven fabric 20 to form a sandwich middle material 40 that is cut into a predetermined shoe upper shape. The woven fabric 30 may be plain-weave fabric or knitted fabric and the best danier value is 4 to 6 dan.

Step D: Bond the shoe upper fabric 10 to one surface of the middle material 40 to form a substrate 50.

Step E: Prepare a mold consisting of an upper die and a lower die. When the upper die and the lower die are closed together, a cavity is defined in between the upper die and the lower die for molding a 3D shoe upper.

Step F: Put the substrate 50 thus obtained from step D in the cavity in between the upper die and lower die of the mold, and then heat the mold to 90° C. for 120 seconds under a molding pressure of 2 kg/m². The molding temperature and pressure can be adjusted within the range of 80˜110° C. and 90˜150 seconds according to the thickness of the substrate.

Step G: After molding, open the mold and take the molded substrate 50, and thus a finished 3D shoe upper is obtained.

In an alternate form of the present invention, step A is performed after step B and step C.

In the above-described steps, the shoe upper fabric, the non-woven fabric and the woven fabric can be separately cut and then bonded together; alternatively, the shoe upper fabric, the non-woven fabric and the woven fabric can be bonded together and then cut into the desired shape. The implementation of the cutting step before or after bonding does not affect the patentability of the method.

Since the low melting staple fiber of the non-woven fabric can be melted in the molding process, the substrate is molded into shape subject to the configuration of the cavity of the mold after pressurized. After removal from the mold, the material temperature of the substrate is lowered, and thus the substrate is shaped in the predetermined shape.

Further, step E can be performed between any two steps from step A to step D or before step A. Performing step E between step D and step F is not a limitation.

According to the method provided by the present invention, it is possible to manufacture a 3D shoe upper structure by means of a heating and pressurizing process. Further, the mold can be configured to provide a pattern therein so that the molded 3D shoe upper can exhibit a 3D pattern.

1. A 3D shoe upper fabrication method comprising the steps of:
Step A: preparing a shoe upper fabric;
Step B: preparing a non-woven fabric containing 20˜30 wt % low melting staple fiber and 70˜80 wt % general fiber;
Step C: bonding two pieces of woven fabric to opposing top and bottom surfaces of said non-woven fabric to form a sandwich middle material and cutting said sandwich middle material into a predetermined shape;
Step D: bonding said shoe upper fabric to one surface of said middle material to form a substrate;
Step E: preparing a mold consisting of an upper die and a lower die, said upper die and said lower die being closable to each other with a cavity defined in therebetween for molding a 3D shoe upper;
Step F: putting said substrate in said cavity and then heating and pressurizing said mold at 80˜110° C. for 90˜150 seconds to mold said substrate into a 3D shoe upper; and
Step G: opening said mold and removing the said 3D shoe upper thus formed;
wherein said general fiber is selectively Polyester or Nylon.

2. The 3D shoe upper fabrication method as claimed in claim 1, wherein the pressure applied to said mold in Step F is 2 kg/m².

3. The 3D shoe upper fabrication method as claimed in claim 1, wherein the melting point of said low melting staple fiber is below 120° C.

4. The 3D shoe upper fabrication method as claimed in claim 1, wherein the thickness of said non-woven fabric is in the range of 4˜6 mm.

5. (canceled)

6. The 3D shoe upper fabrication method as claimed in claim 1, wherein said shoe upper fabric comprises a pattern.

7. The 3D shoe upper fabrication method as claimed in claim 6, wherein said pattern is formed on said shoe upper fabric by weaving.

8. The 3D shoe upper fabrication method as claimed in claim 6, wherein said pattern is formed on said shoe upper fabric by printing.
